(19) United States
(12) Patent Application Publication
(10) Pub. No.: US 2005/0226490 A1
(43) Pub. Date: Oct. 13, 2005

(54) Method and apparatus for improved vision detector image capture and analysis

(76) Inventors: Brian S. Phillips, Sherborn, MA (US); William M. Silver, Weston, MA (US); Brian V. Mirtich, Medfield, MA (US)

Correspondence Address: ARTHUR J. O'DEA;LEGAL DEPARTMENT, COGNEX CORPORATION, ONE VISION DRIVE, NATICK, MA, 01760-2077, US

(21) Appl. No.: 11/094,650

(22) Filed: Mar. 30, 2005

Related U.S. Application Data
(63) Continuation-in-part of application No. 10/865,155, filed on Jun. 9, 2004.
(63) Continuation-in-part of application No. 10/979,535, filed on Nov. 2, 2004.
(63) Continuation-in-part of application No. 10/059,512, filed on Jan. 29, 2002.

(51) Int. Cl. G06K 9/00

(52) U.S. Cl. 382/141

(57) ABSTRACT

Disclosed are methods and apparatus for improvements to image capture and analysis for vision detectors. The improvements provide for asynchronous capture and analysis and allow high frame rates to be maintained when image analysis may under certain conditions comprise a significantly longer time interval than image capture. The improvements prevent memory buffer overflow and provide for short and predictable decision delays even though an arbitrary and potentially unlimited number of images are captured and analyzed for each object.

### RELATED APPLICATIONS

This application is a continuation-in-part of the following co-pending U.S. patent applications:
Ser. No. 10/865,155, entitled METHOD AND APPARATUS FOR VISUAL DETECTION AND INSPECTION OF OBJECTS, by William M. Silver, filed Jun. 9, 2004, the teachings of which are expressly incorporated herein by reference, and referred to herein as the “Vision Detector Method and Apparatus”;
Ser. No. 10/979,535, entitled METHOD FOR SETTING PARAMETERS OF A VISION DETECTOR USING PRODUCTION LINE INFORMATION, by Brian Mirtich and William M. Silver, filed Nov. 2, 2004, a continuation-in-part of Vision Detector Method and Apparatus, the teachings of which are expressly incorporated herein by reference, and referred to herein as the “Parameter Setting Method and Apparatus”; and
Ser. No. 11/059,512, entitled Method and Apparatus for Automatic Visual Detection, Recording, and Retrieval of Events, by William M. Silver and Brian S. Phillips, filed Feb. 16, 2005, a continuation-in-part of Vision Detector Method and Apparatus, the teachings of which are expressly incorporated herein by reference, and referred to herein as the “Event Detection Method and Apparatus”.

### BACKGROUND OF THE INVENTION

1. Field of the Invention

The invention relates to automated visual event detection, object detection and inspection, and the related fields of industrial machine vision and automated image analysis.

2. Description of the Related Art

It is well-known in the art to use machine vision systems and methods to analyze objects, for example to identify, locate, or inspect objects being manufactured on a production line. Such systems generally receive a trigger signal from an external device, such as a photodetector, to indicate that an object is present in the field of view of the machine vision system. Upon receiving a trigger signal, the machine vision system will capture a digital image of the object, analyze the image using a variety of well-known methods to produce useful information, such as identity, location, and/or quality or the object, and report the information to external automation equipment for use in the manufacturing process.

Speed of operation is almost always at a premium for machine vision systems and methods. Objects are generally manufactured at high rates, and image analysis operations usually require sophisticated computational shortcuts to meet time budgets. The rapid rise in digital computer speed over the years has not eased the burden of providing high-speed operation for machine vision systems, but rather has been applied to ever-increasing sophistication of image analysis methods so that more accurate and reliable decisions can be made.

One common method for increasing the speed of a machine vision system is to allow an image of an object to be captured simultaneously with the analysis of the image corresponding to the previous object. With such an arrangement, the rate at which a machine vision system can analyze objects is determined by the longer of the capture time and the analysis time, instead of the sum of those times. In cases where capture and analysis times are roughly equal, an improvement of almost a factor of two in object analysis rate can be achieved. If the object presentation rate exceeds the analysis rate of the machine vision system, trigger signals will be ignored and the objects corresponding to those signals will not be analyzed.

Systems that allow simultaneous capture and analysis use two digital memory buffers, one to hold a new image being captured and one to hold the previous image being analyzed. The two buffers switch roles after each capture and analysis cycle is complete, and so they are often called “ping-pong” buffers.

It is also known in the art to capture images asynchronously relative to image analysis, so that images are captured whenever a trigger signal arrives and stored for analysis at some later time. Such an arrangement is suitable where the image capture time is significantly shorter than the image analysis time, where the object presentation rate and/or the image analysis time is variable and the average object presentation rate does not exceed the average image analysis rate, and where the information produced by the analysis is not needed too soon after the trigger signal. The captured images are stored in a first-in, first-out (FIFO) memory buffer for subsequent analysis. If the average object presentation rate exceeds the average image analysis rate over a period of time whose length is determined by the size of the FIFO buffer, then the FIFO will overflow and triggers will be ignored.

The Vision Detector Method and Apparatus teaches novel methods and systems for analyzing objects by capturing and analyzing digital images of those objects. These teachings provide fertile ground for innovation leading to improvements beyond the scope of the original teachings. In the following section the Vision Detector Method and Apparatus is briefly summarized, and a subsequent section lays out the problems to be addressed by the present invention.

Vision Detector Method and Apparatus

The Vision Detector Method and Apparatus provides systems and methods for automatic optoelectronic detection and inspection of objects, based on capturing digital images of a two-dimensional field of view in which an object to be detected or inspected may be located, and then analyzing the images and making decisions. These systems and methods analyze patterns of brightness reflected from extended areas, handle many distinct features on the object, accommodate line changeovers through software means, and handle uncertain and variable object locations. They are less expensive and easier to set up than prior art machine vision systems, and operate at much higher speeds. These systems and methods furthermore make use of multiple perspectives of moving objects, operate without triggers, provide appropriately synchronized output signals, and provide other significant and useful capabilities that will be apparent to those skilled in the art.

One aspect of the Vision Detector Method and Apparatus is an apparatus, called a vision detector, that can capture and analyze a sequence of images at higher speeds than prior art vision systems. An image in such a sequence that is captured and analyzed is called a frame. The rate at which frames are captured and analyzed, called the frame rate, is sufficiently high that a moving object is seen in multiple consecutive frames as it passes through the field of view (FOV). Since the object moves somewhat between successive frames, it is located in multiple positions in the FOV, and therefore it is seen from multiple viewing perspectives and positions relative to the illumination.

Another aspect of the Vision Detector Method and Apparatus is a method, called dynamic image analysis, for inspecting objects by capturing and analyzing multiple frames for which the object is located in the field of view, and basing a result on a combination of evidence obtained from each of those frames. The method provides significant advantages over prior art machine vision systems that make decisions based on a single frame.

Yet another aspect of the Vision Detector Method and Apparatus is a method, called visual event detection, for detecting events that may occur in the field of view. An event can be an object passing through the field of view, and by using visual event detection the object can be detected without the need for a trigger signal.

Additional aspects of the Vision Detector Method and Apparatus will be apparent by a study of the figures and detailed descriptions given therein.

In order to obtain images from multiple perspectives, it is desirable that an object to be detected or inspected moves no more than a small fraction of the field of view between successive frames, often no more than a few pixels. According to the Vision Detector Method and Apparatus, it is generally desirable that the object motion be no more than about one-quarter of the FOV per frame, and in typical embodiments no more than 5% or less of the FOV. It is desirable that this be achieved not by slowing down a manufacturing process but by providing a sufficiently high frame rate. In an example system the frame rate is at least 200 frames/second, and in another example the frame rate is at least 40 times the average rate at which objects are presented to the vision detector.

An exemplary system is taught that can capture and analyze up to 500 frames/second. This system makes use of an ultra-sensitive imager that has far fewer pixels than prior art vision systems. The high sensitivity allows very short shutter times using very inexpensive LED illumination, which in combination with the relatively small number of pixels allows very short image capture times. The imager is interfaced to a digital signal processor (DSP) that can receive and store pixel data simultaneously with analysis operations. Using methods taught therein and implemented by means of suitable software for the DSP, the time to analyze each frame generally can be kept to within the time needed to capture the next frame. The capture and analysis methods and apparatus combine to provide the desired high frame rate. By carefully matching the capabilities of the imager, DSP, and illumination with the objectives of the invention, the exemplary system can be significantly less expensive than prior art machine vision systems.

The method of visual event detection involves capturing a sequence of frames and analyzing each frame to determine evidence that an event is occurring or has occurred. When visual event detection is used to detect objects without the need for a trigger signal, the analysis would determine evidence that an object is located in the field of view.

In an exemplary method the evidence is in the form of a value, called an object detection weight, that indicates a level of confidence that an object is located in the field of view. The value may be a simple yes/no choice that indicates high or low confidence, a number that indicates a range of levels of confidence, or any item of information that conveys evidence. One example of such a number is a so-called fuzzy logic value, further described therein. Note that no machine can make a perfect decision from an image, and so will instead make judgments based on imperfect evidence.

When performing object detection, a test is made for each frame to decide whether the evidence is sufficient that an object is located in the field of view. If a simple yes/no value is used, the evidence may be considered sufficient if the value is “yes”. If a number is used, sufficiency may be determined by comparing the number to a threshold. Frames where the evidence is sufficient are called active frames. Note that what constitutes sufficient evidence is ultimately defined by a human user who configures the vision detector based on an understanding of the specific application at hand. The vision detector automatically applies that definition in making its decisions.

When performing object detection, each object passing through the field of view will produce multiple active frames due to the high frame rate of the vision detector. These frames may not be strictly consecutive, however, because as the object passes through the field of view there may be some viewing perspectives, or other conditions, for which the evidence that the object is located in the field of view is not sufficient. Therefore it is desirable that detection of an object begins when an active frame is found, but does not end until a number of consecutive inactive frames are found. This number can be chosen as appropriate by a user.

Once a set of active frames has been found that may correspond to an object passing through the field of view, it is desirable to perform a further analysis to determine whether an object has indeed been detected. This further analysis may consider some statistics of the active frames, including the number of active frames, the sum of the object detection weights, the average object detection weight, and the like.

The method of dynamic image analysis involves capturing and analyzing multiple frames to inspect an object, where “inspect” means to determine some information about the status of the object. In one example of this method, the status of an object includes whether or not the object satisfies inspection criteria chosen as appropriate by a user.

In some aspects of the Vision Detector Method and Apparatus dynamic image analysis is combined with visual event detection, so that the active frames chosen by the visual event detection method are the ones used by the dynamic image analysis method to inspect the object. In other aspects of the Vision Detector Method and Apparatus, the frames to be used by dynamic image analysis can be captured in response to a trigger signal.

Each such frame is analyzed to determine evidence that the object satisfies the inspection criteria. In one exemplary method, the evidence is in the form of a value, called an object pass score, that indicates a level of confidence that the object satisfies the inspection criteria. As with object detection weights, the value may be a simple yes/no choice that indicates high or low confidence, a number, such as a fuzzy logic value, that indicates a range of levels of confidence, or any item of information that conveys evidence.

The status of the object may be determined from statistics of the object pass scores, such as an average or percentile of the object pass scores. The status may also be determined by weighted statistics, such as a weighted average or weighted percentile, using the object detection weights. Weighted statistics effectively weight evidence more heavily from frames wherein the confidence is higher that the object is actually located in the field of view for that frame.

Evidence for object detection and inspection is obtained by examining a frame for information about one or more visible features of the object. A visible feature is a portion of the object wherein the amount, pattern, or other characteristic of emitted light conveys information about the presence, identity, or status of the object. Light can be emitted by any process or combination of processes, including but not limited to reflection, transmission, or refraction of a source external or internal to the object, or directly from a source internal to the object.

One aspect of the Vision Detector Method and Apparatus is a method for obtaining evidence, including object detection weights and object pass scores, by image analysis operations on one or more regions of interest in each frame for which the evidence is needed. In an example of this method, the image analysis operation computes a measurement based on the pixel values in the region of interest, where the measurement is responsive to some appropriate characteristic of a visible feature of the object. The measurement is converted to a logic value by a threshold operation, and the logic values obtained from the regions of interest are combined to produce the evidence for the frame. The logic values can be binary or fuzzy logic values, with the thresholds and logical combination being binary or fuzzy as appropriate.

For visual event detection, evidence that an object is located in the field of view is effectively defined by the regions of interest, measurements, thresholds, logical combinations, and other parameters further described herein, which are collectively called the configuration of the vision detector and are chosen by a user as appropriate for a given application of the invention. Similarly, the configuration of the vision detector defines what constitutes sufficient evidence.

For dynamic image analysis, evidence that an object satisfies the inspection criteria is also effectively defined by the configuration of the vision detector.

Discussion of the Problem

It is clear from the above summary and from a detailed reading of Vision Detector Method and Apparatus that it is advantageous for a vision detector to maintain a high frame rate. As taught therein, the high frame rate can be achieved in part by capturing a frame simultaneously with the analysis of the previous frame, using for example a ping-pong arrangement, and by keeping the analysis time comparable to or below the capture time. While it is not required that the analysis time be kept comparable to or below the capture time, if analysis takes more time than capture then the frame rate will be lower.

In some applications it is desirable that the analysis time be, under certain conditions, significantly longer than the capture time, and yet the frame rate be determined by the capture time only, so that it remains high even under those conditions. The prior art method of triggered asynchronous capture with FIFO buffer, used by some machine vision systems, is not sufficient for vision detectors, where images may be captured and analyzed continuously, whether or not an object is present, and not in response to a trigger. Thus there is a need for improved methods and systems that can allow long analysis times while still capturing frames at the highest rate.

### SUMMARY OF THE INVENTION

The invention teaches improvements on methods and systems taught in Vision Detector Method and Apparatus for detecting and inspecting objects in the field of view of a vision detector. The invention replaces the synchronous, overlapped image capture and analysis methods and systems taught therein with asynchronous capture and analysis methods and systems that permit higher frame rates than previously possible under conditions where the time to analyze frames exceeds the time to capture them.

The invention provides for capturing and analyzing a sequence of frames, where each frame is an image of the field of view of a vision detector. Some of these frames will correspond to periods of time, called inactive states, where no object appears to be present in the field of view, and others will correspond to periods of time, called active states, where an object does appear to be present in the field of view. There may also be periods of time, called idle states, where no frames are being captured and analyzed. Objects are detected and inspected in response to an analysis of the frames during both inactive and active states.

In an illustrative embodiment, capture and analysis are controlled by separate threads in a multi-threaded software environment. The capture and analysis threads run concurrently and asynchronously, communicating by means of various data structures further described below. The capture thread puts frames into a FIFO buffer, and the analysis thread removes them after analysis.

The invention recognizes that an arbitrary and potentially unlimited number of frames are captured and analyzed for each object, some in the active state and most in the inactive state. It is desirable to capture frames at the highest rate during active states, but frames cannot be captured as fast as possible all the time, because the FIFO would quickly overflow in many situations. It is also desirable that the analysis of frames does not lag too far behind their capture in inactive states, as further explained below, in order to maintain the utility of output signals synchronized to the mark time. Thus the invention recognizes that it is desirable to control frame capture differently depending on whether or not an object appears to be present in the field of view.

The invention provides a variety of methods and systems to prevent FIFO overflow, manage the lag time, maintain high frame rate, and provide other useful capabilities that will be apparent to one skilled in the art.

One aspect of the invention includes an analysis step or process that takes less time when no object appears to be present in the field of view than when a object does appear to be present, which is desirable for maintaining a high frame rate in inactive states. In an illustrative embodiment, analyzing a frame comprises one or more detection substeps and one or more inspection substeps. If the detection substeps reveal that no object appears to be present in a given frame, the inspection substeps can be skipped, resulting in quicker analysis for that frame. Furthermore, in many cases it is not necessary to perform all of the detection substeps in order to judge that no object appears to be present.

In an illustrative embodiment, the detection and inspection substeps are asynchronous, and capture, detection, and inspection are controlled by three separate threads in a multi-threaded environment.

Another aspect of the invention includes a step or process that limits the number of frames to be captured and analyzed in an active state, so that the FIFO does not overflow and the time needed to inspect the object is predictable.

Yet another aspect of the invention includes a step or process that limits the lag time between the capture and analysis of a frame in inactive states. This step or process may result in a higher frame rate during active states, when high frame rate is most desirable, than inactive states, when other considerations apply.

A further aspect of the invention includes a step or process that flushes (discards) without analysis certain frames that have been captured, because analysis of previous frames reveals that analysis of the flushed frames is not necessary to detect or inspect an object.

### BRIEF DESCRIPTION OF THE DRAWINGS

The invention will be more fully understood from the following detailed description, in conjunction with the accompanying figures, wherein:

FIG. 1 shows a timeline that illustrates a typical operating cycle of a prior art machine vision system;

FIG. 2 shows a timeline that illustrates a typical operating cycle of a prior art machine vision system where image capture and analysis are asynchronous;

FIG. 3 shows a timeline that illustrates a typical operating cycle for a vision detector using visual event detection;

FIG. 4 shows a timeline that illustrates a typical operating cycle for a vision detector using a trigger signal;

FIG. 5 shows a timeline that breaks down example analysis steps in an illustrative embodiment of the invention;

FIG. 6 shows a logic view of a configuration of an illustrative embodiment of a vision detector that could give rise to the example analysis steps shown in the timeline of FIG. 5;

FIG. 7 shows a timeline of a typical operating cycle for an illustrative embodiment of a vision detector using visual event detection to detect objects, and operating according to the present invention;

FIG. 8 shows a flowchart of the capture thread in an illustrative embodiment;

FIG. 9 shows a flowchart of the analyze thread in an illustrative embodiment;

FIG. 10 shows a timeline of a typical operating cycle for an alternate illustrative embodiment of a vision detector using visual event detection to detect objects;

FIG. 11 shows a timeline of a typical operating cycle for an illustrative embodiment of a vision detector using an external trigger and operating according to the present invention;

FIG. 12 shows a high-level block diagram for a vision detector in a production environment; and

FIG. 13 shows a block diagram of an illustrative embodiment of a vision detector.

### DETAILED DESCRIPTION OF THE INVENTION

Discussion of Prior Art

FIG. 1 shows a timeline that illustrates a typical operating cycle of a prior art machine vision system. Shown are the operating steps for two exemplary objects 100 and 110. The operating cycle contains four steps: trigger 120, image capture 130, analyze 140, and report 150. During the time between cycles 160, the vision system is idle. The timeline is not drawn to scale, and the amount of time taken by the indicated steps will vary significantly among applications.

The trigger 120 is some event external to the vision system, such as a signal from a photodetector, or a message from a Programmable Logic Controller (PLC), computer, or other piece of automation equipment.

The image capture step 130 starts by exposing a two-dimensional array of photosensitive elements, called pixels, for a brief period, called the integration or shutter time, to an image that has been focused on the array by a lens. Each pixel measures the intensity of light falling on it during the shutter time. The measured intensity values are then converted to digital numbers and stored in the memory of the vision system.

During the analyze step 140 the vision system operates on the stored pixel values using methods well-known in the art to determine the status of the object being inspected. During the report step 150, the vision system communicates information about the status of the object to appropriate automation equipment, such as a PLC.

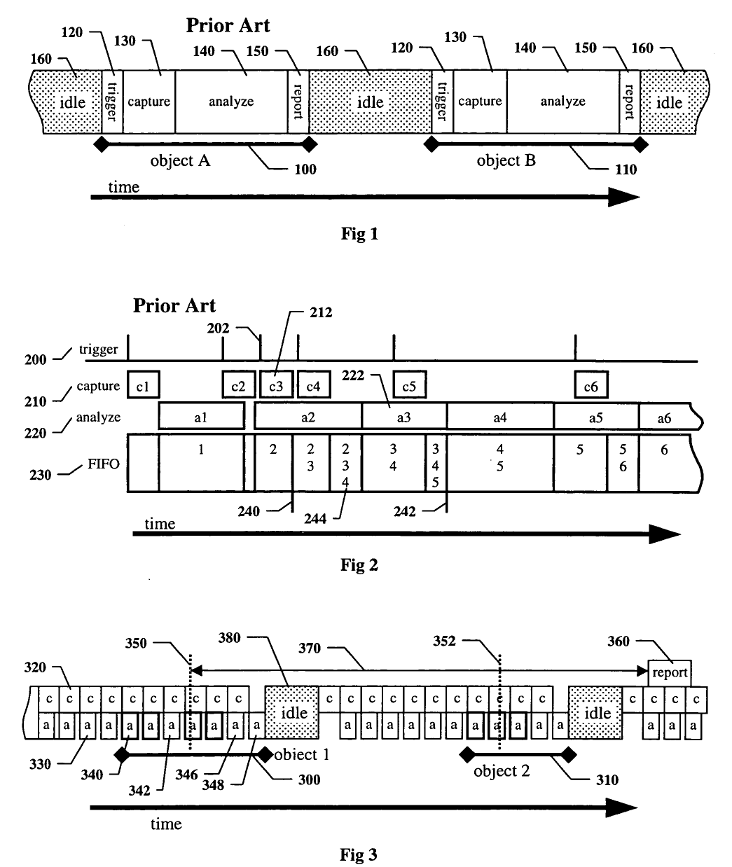

FIG. 2 shows a timeline that illustrates a typical operating cycle of a prior art machine vision system where image capture and analysis are asynchronous, and where a first-in first-out buffer (FIFO) is used to hold captured images being and waiting to be analyzed. Four rows are illustrated along the timeline: trigger row 200, capture row 210, and analysis row 220 show steps in the operating cycle, and FIFO row 230 shows the contents of the FIFO at various stages.

Trigger row 200 shows trigger signals input to the machine vision system that indicate that an object is present in the field of view, including example trigger 202. Note that trigger steps in trigger row 200 are equivalent to the trigger 120 steps of FIG. 1, illustrated differently for convenience only. Note that the object presentation intervals, illustrated by the spacing between triggers, is variable.

Capture row 210 shows image capture steps, including example capture step 212 that captures image 3 in the illustrated sequence (the image numbers are arbitrary). Note that each trigger signal starts an image capture, so that example trigger 202 starts example capture step 212.

Analysis row 220 shows image analysis steps, including example analysis step 222 that analyzes image 3. Note that in the example of FIG. 2 the analysis steps are of varying duration, which is fairly typical.

FIFO row 230 shows the contents of the FIFO, including example FIFO state 244 that shows the FIFO containing images 2, 3, and 4. An image is added to the bottom of the FIFO at the end of a capture step, and removed from the top at the end of an analysis step. For example, at the end of example capture step 212, corresponding to first time mark 240, image 3 is added to the FIFO, and at the end of example analysis step 222, corresponding to second time mark 242 image 3 is removed from the FIFO.

Note that the timing of the steps in analysis row 220 is asynchronous with the timing of steps in capture row 210. Analysis proceeds whenever the FIFO is not empty, using the oldest (“first-in”) image shown at the top in FIFO row 230, regardless of what is currently being captured. This arrangement can handle a temporary condition where the analysis times are much longer than the object presentation intervals, as shown in the example of FIG. 2. The maximum duration of this temporary condition depends on the size of the FIFO. If the condition persists too long, the FIFO will fill up and a captured image will have to be discarded. Furthermore, if the object presentation interval is shorter than the image capture time, there will be no way to capture a new image and the trigger must be ignored.

Selected Teachings of Vision Detector Method and Apparatus

FIG. 3 shows a timeline that illustrates a typical operating cycle for a vision detector using visual event detection to detect objects. Boxes labeled “c”, such as box 320, represent image capture. Boxes labeled “a”, such as box 330, represent image analysis. It is desirable that capture “c” of the next image be overlapped with analysis “a” of the current image, so that (for example) analysis step 330 analyzes the image captured in capture step 320. In this timeline, analysis is shown as taking less time than capture, but in general analysis will be shorter or longer than capture depending on the application details.

If capture and analysis are overlapped, the rate at which a vision detector can capture and analyze images is determined by the longer of the capture time and the analysis time. This is the “frame rate”.

The Vision Detector Method and Apparatus allows objects to be detected reliably without a trigger signal, such as that provided by a photodetector. Note that in FIG. 3 there is no trigger step such as trigger 120 in FIG. 1.

Referring again to FIG. 3, a first portion 300 of the timeline corresponds to the inspection of a first object, and contains the capture and analysis of seven frames. A second portion 310 corresponds to the inspection of a second object, and contains five frames.

Each analysis step first considers the evidence that an object is present. Frames where the evidence is sufficient are called active. Analysis steps for active frames are shown with a thick border, for example analysis step 340. In an illustrative embodiment, inspection of an object begins when an active frame is found, and ends when some number of consecutive inactive frames are found. In the example of FIG. 3, inspection of the first object begins with the first active frame corresponding to analysis step 340, and ends with two consecutive inactive frames, corresponding to analysis steps 346 and 348. Note that for the first object, a single inactive frame corresponding to analysis step 342 is not sufficient to terminate the inspection.

At the time that inspection of an object is complete, for example at the end of analysis step 348, decisions are made on the status of the object based on the evidence obtained from the active frames. In an illustrative embodiment, if an insufficient number of active frames were found then there is considered to be insufficient evidence that an object was actually present, and so operation continues as if no active frames were found. Otherwise an object is judged to have been detected, and evidence from the active frames is judged in order to determine its status, for example pass or fail. A variety of methods may be used to detect objects and determine status within the scope of Vision Detector Method and Apparatus; some are described therein and many others will occur to those skilled in the art.

Once an object has been detected and a judgment made, a report may be made to appropriate automation equipment, such as a PLC, using signals well-known in the art. In such a case a report step similar to report 150 in FIG. 1 would appear in the timeline. The example of FIG. 3 corresponds instead to a setup where the vision detector is used to provide an output signal synchronized to the time that an object crosses a fixed reference point, called the mark point, for example to control a downstream reject actuator. By considering the position of the object in the active frames as it passes through the field of view, as further taught in Vision Detector Method and Apparatus, the vision detector estimates the mark time 350 and 352 at which the object crosses the mark point. Note that in cases where a shaft encoder is used, the mark time is actually an encoder count; the reader will understand that time and count can be used interchangeably. A report 360, consisting of a pulse of appropriate duration, is issued after a precise output delay 370 in time or encoder count from the mark time 350.

Note that the report 360 may be delayed well beyond the inspection of subsequent objects such as that corresponding to second portion 310. The vision detector uses well-known first-in first-out (FIFO) buffer methods to hold the reports until the appropriate time.

Once inspection of an object is complete, the vision detector may enter an idle step 380. Such a step is optional, but may be desirable for several reasons. If the maximum object rate is known, there is no need to be looking for an object until just before a new one is due. An idle step will eliminate the chance of false object detection at times when an object couldn't arrive, and will extend the lifetime of the illumination system because the lights can be kept off during the idle step.

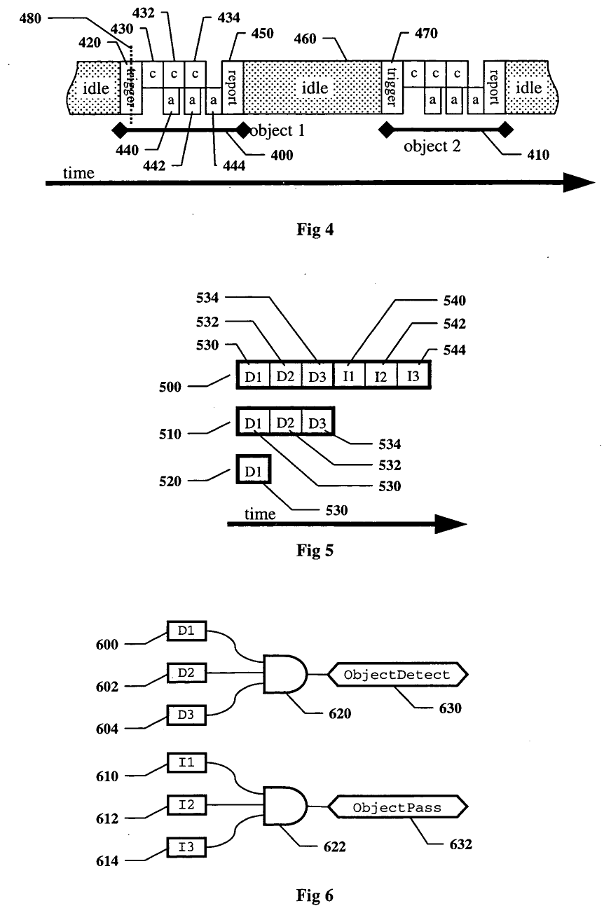

FIG. 4 shows a timeline that illustrates a typical operating cycle for a vision detector in external trigger mode. A trigger step 420, similar in function to prior art trigger step 120, begins inspection of a first object 400. A sequence of image capture steps 430, 432, and 434, and corresponding analysis steps 440, 442, and 444 are used for dynamic image analysis. As in visual event detection mode, it is desirable that the frame rate be sufficiently high that the object moves a small fraction of the field of view between successive frames, often no more than a few pixels per frame. After a fixed number of frames, the number being chosen based on application details, the evidence obtained from analysis of the frames is used to make a final judgment on the status of the object, which in one embodiment is provided to automation equipment in a report step 450. Following the report step, an idle step 460 is entered until the next trigger step 470 that begins inspection of a second object 410.

In another embodiment, the report step is delayed in a manner equivalent to that shown in FIG. 3. In this embodiment, the mark time 480 is the time (or encoder count) corresponding to the trigger step 420.

Operation of the Present Invention

FIG. 5 shows a timeline that breaks down example analysis steps in an illustrative embodiment of the invention. Each analysis step in this example comprises an analysis of up to six regions of interest of the field of view. D1 substep 530, D2 substep 532, and D3 substep 534 correspond to the analysis of three regions of interest whose combined evidence is used to detect an object. I1 substep 540, I2 substep 542, and I3 substep 544 correspond to the analysis of three regions of interest whose combined evidence is used to inspect the object. In the example of FIG. 5 the six detection and inspection substeps are shown as having equal duration, but in general this need not be the case.

For first example analysis step 500, an object is found and inspected-all six detection and inspection substeps are executed. This corresponds to an active frame. Most frames are inactive, however—no object is found and the inspection substeps need not be carried out. In second example analysis step 510 the three detection substeps are executed, but no object is found and so the inspection substeps are not done, resulting in a shorter duration for the analysis.

Furthermore, in many frames it is possible to decide that no object is found without executing all of the detection substeps. In third example analysis step 520, D1 substep 530 reveals that no object is found, and so no other substeps need be executed. Thus the average time to decide that no object is found may be significantly shorter than the longest time to make that decision.

Following the teachings of Vision Detector Method and Apparatus, it is important to distinguish between finding an object in a given frame, and detecting an object based on the evidence of many frames. An object may be present in a given frame but not found, or appear to be found but not actually present, because viewing conditions in that frame are poor or misleading for some reason. The methods of visual event detection and dynamic image analysis are designed in part to prevent an isolated poor frame from producing false results. Thus it is typically the case that an object is found in a given frame if and only if one is actually present, but this is not guaranteed. The following discussions of the invention are based on examples where an object is found if and only if one is actually present, but the reader will understand that methods and systems herein described will still work even when that condition does not hold for every frame.

FIG. 6 shows a logic view of a configuration of an illustrative embodiment of a vision detector that could give rise to the example analysis steps shown in the timeline of FIG. 5. The logic view of FIG. 6 follows the teachings of Vision Detector Method and Apparatus, and is similar to illustrative embodiments taught therein. The detection substeps of FIG. 5 correspond to running Gadgets necessary to determine the input to the ObjectDetect Judge. Analysis substeps correspond to running Gadgets necessary to determine the input to the ObjectPass Judge. Note that the time needed to run Gadgets that do not analyze regions of interest, such as Gates, is generally negligible and not considered in the above discussion of FIG. 5. The substeps of FIG. 5 correspond therefore to running Photos.

Referring to FIG. 6, D1 Photo 600, D2 Photo 602, and D3 Photo 604 are wired to AND Gate 620, which is wired to ObjectDetect Judge 630. I1 Photo 610, I2 Photo 612, and I3 Photo 614 are wired to AND Gate 622, which is wired to ObjectPass Judge 632. An analysis substep of FIG. 5 corresponds to running the like-named Photo of FIG. 6.

As taught in Vision Detector Method and Apparatus:
“The act of analyzing a frame consists of running each Gadget once, in an order determined to guarantee that all logic inputs to a Gadget have been updated before the Gadget is run. In some embodiments, a Gadget is not run during a frame where its logic output is not needed.”

Thus, for a frame where ObjectDetect Judge 630 determines that no object has been found, the logic output of AND Gate 622 is not needed and therefore the logic outputs of I1 Photo 610, I2 Photo 612, and I3 Photo 614 are not needed. Such a case may correspond to second example analysis step 510 or third example analysis step 520. For a frame where D1 Photo 600 produces a zero output, AND Gate 620 may decide that the logic outputs of D2 Photo 602 and D3 Photo 604 are not needed. Such a case may correspond to third example analysis step 520. In an alternate embodiment, the same decision may be reached if D1 Photo 600 produces a output less than some object detection threshold such as 0.5.

It will be understood that the foregoing examples are illustrative and not limiting. Similar examples can be made using any number of Photos and any combination of AND Gates and OR Gates, and with different rules for breaking an image analysis step into substeps and deciding which substeps to execute. Furthermore, while it is desirable that the duration of analysis steps is shortened when no object is detected, it is not necessary for practice of the invention, as will become clear below.

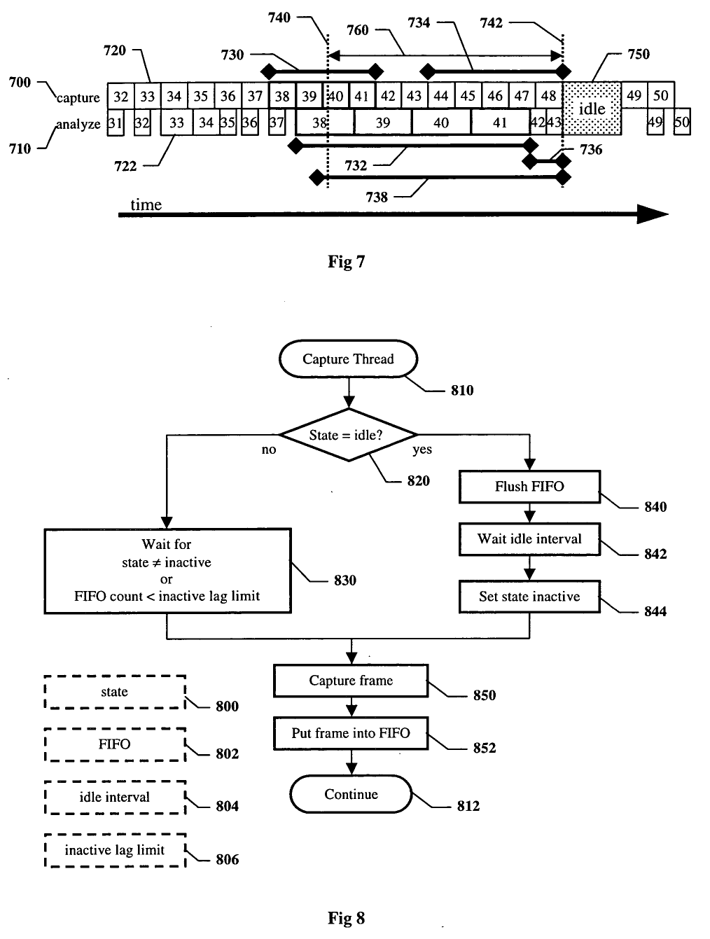

FIG. 7 shows a timeline of a typical operating cycle for an illustrative embodiment of a vision detector using visual event detection to detect objects, and operating according to the present invention. Capture row 700 shows image capture steps, including example capture step 720 that captures frame 33 in the illustrated sequence (the frame numbers are arbitrary). Analysis row 710 shows image analysis steps, including example analysis step 722 that analyzes frame 33.

Note that the analysis steps are of varying duration, some shorter and some longer than the substantially fixed image capture time, due in part to decisions that no object has been found as explained above for FIG. 5. This is a desirable but not necessary condition for practice of the invention. If the analysis steps were always shorter than the capture steps, the present invention would not be needed, although it would do no harm and could be used. As further described below the invention can be used to significant advantage when most or all of the analysis steps are of longer duration that the capture steps, but this condition is less desirable.

In the example of FIG. 7, an object is present in the field of view of the vision detector during the capture of four frames 38-41, corresponding to first interval 730, whose capture steps are highlighted with a thick border. The object crosses the mark point at mark time 740. These frames are analyzed during second interval 732, with analyze steps also highlighted with a thick border. Frames 38-41 are the active frames for this object. Consecutive inactive frames 42 and 43, analyzed during third interval 736, terminate the inspection. A decision that an object has indeed been detected, and whether or not it passes inspection, is made at decision time 742, after which idle step 750 is entered. Note that frames 44-48, captured during fourth interval 734, are discarded without being analyzed.

The decision delay 760, measured from mark time 740 to decision time 742, will be somewhat variable from object to object. When a synchronized output signal, such as report 360 (FIG. 3), is produced, the output delay 370 (FIG. 3) must be at least as long as the longest expected decision delay 760 in order to maintain synchronization. Further discussion of these and other issues related to mark time and output synchronization can be found in Vision Detector Method and Apparatus, particularly in reference to FIGS. 31, 32, 33, 34, and 36, Parameter Setting Method and Apparatus, particularly in reference to FIG. 16, and Event Detection Method and Apparatus, particularly in reference to FIGS. 18 and 19. Note that figures not specifically mentioned above may also provide useful information.

Note that the active frames 38-41, where an object is found and inspected, are of substantially longer duration than inactive frames as explained above. These frames are also of substantially longer duration than image capture, but as can been seen this has no effect on the frame rate, which is determined solely by the capture time. Without the present invention, the frame rate would have to be slowed down to match the analysis. The higher frame rate provides more images for dynamic image analysis and visual event detection, and greater accuracy for mark time calculation. Note that since mark time is calculated based on recorded frame capture times, it doesn't matter that the analysis is done much later.

Note that the analysis of inactive frames may also be of longer duration than image capture, such as for frame 33 corresponding to example analysis step 722, without effecting the frame rate.

Note further that decision time 742 happens somewhat sooner with the present invention than with the ping-pong capture/analyze arrangement taught in Vision Detector Method and Apparatus. With a ping-pong arrangement, capture of frame 43 would begin when analysis of frame 42 begins, but since the analysis of frame 42 is shorter than the capture of frame 43, the analysis of frame 43 would happen somewhat later than the arrangement of FIG. 7, where frame 43 has long since been captured and is immediately ready for analysis.

In an illustrative embodiment, a vision detector is in an active state for intervals during which an object appears to be present in the field of view, an inactive state for intervals during which frames are being captured and analyzed to detect an object but none appears to be present, and an idle state for intervals during which frames are not being captured and analyzed. In the example of FIG. 7, the vision detector is the active state during active interval 738, which starts at a time during the analysis of frame 38 when the detection substeps are complete and the first active frame is identified, and ends after the analysis of frame 43 when two consecutive inactive frames have been found. The vision detector is in the idle state during idle step 750, and the inactive state at other times.

With the present invention, capture and analysis are substantially asynchronous. Herein substantially asynchronous means that the relative timing of capture and analysis is not predetermined, but rather is determined dynamically by conditions unfolding in the field of view. There may be conditions wherein capture and analysis do proceed in what appears to be synchronization, or when capture and analysis are deliberately synchronized to achieve a desirable result, but these conditions are not predetermined and occur in response to what is happening in the field of view.

In an illustrative embodiment, a conventional FIFO buffer is used to hold frames, following an arrangement similar to that used for the prior art machine vision system of FIG. 2. Frames are added to the FIFO when captured, and removed from the FIFO when analysis is complete. Clearly, other arrangements can be made within the scope of the invention, including but not limited to details on when frames are added and/or removed, and how the buffers are managed.

Adding asynchronous capture/analysis with a FIFO buffer to a vision detector, however, is not sufficient to produce a practical method or system, particularly when visual event detection is being used. The problems that might arise are not obvious, nor are the solutions. The problems arise in part because an arbitrary and potentially unlimited number of frames are captured and analyzed for each object, some when the object is present in the field of view (active state) and most when no object is present (inactive state). There is no trigger signal to indicate that an object is present and therefore a frame should be captured. One cannot, however, simply capture frames as fast as possible all the time, because the FIFO would quickly overflow in many situations. Even when the FIFO does not overflow, if the analysis of frames lags too far behind their capture in certain situations, the decision delay 760 will become long and unpredictable, severely reducing the utility of output signals synchronized to the mark time.

The invention recognizes that it is desirable to control frame capture differently depending on whether or not an object appears to be present in the field of view. It is desirable for robustness and mark timing accuracy to capture frames as fast as possible during active states. While analysis of those frames may be lengthy because most are active frames with all detection and inspection substeps being executed, the number of frames to be captured and analyzed during an active state is predictable based on the expected speed of objects and the known size of the field of view, and can be controlled by appropriate configuration parameters so as not to exceed predefined limits. The ability to predict and control the active state frame count is part of a structure used in an illustrative embodiment to insure that the FIFO will not overflow, and that the decision delay is short and predictable.

Another part of the above structure used in an illustrative embodiment keeps the count of frames in the FIFO (which corresponds to the time lag from capture to analysis) predictable during an inactive state, so that the count is predictable when an active state begins. This is accomplished in the illustrative embodiment by providing that frame capture in the inactive state waits until the FIFO contains no more than a configurable number of frames. Since analysis is generally faster in an inactive state (no object is detected), it is typically the case that the FIFO stays nearly empty even at the maximum frame rate. If analysis takes longer than capture for some reason, due for example to some temporary condition or because object detection requires significant analysis, frame capture will wait as necessary to prevent it from getting too far ahead of analysis, and the frame rate will slow down. Note that it is usually desirable that the FIFO be nearly empty during an inactive state.

Yet another part of the above structure used in an illustrative embodiment provides that the FIFO be flushed (all frames discarded) during an idle state. Analysis during an active state may get significantly behind frame capture, with the FIFO nearly filling up, and flushing the FIFO insures that the next inactive state begins with an empty FIFO and with analysis fully caught up to frame capture.

In an illustrative embodiment, frame capture and analysis are controlled by a suitable programmable digital processor, using software instructions that provide for multi-threaded operation of conventional and well-known design. Two threads run concurrently, one for frame capture and one for analysis. It is desirable that the capture thread run at higher priority than the analysis thread. Other threads may be running as well, depending on the application. The threads share certain data structures that provide for communication and, when necessary, synchronization between the threads. These data structures reside in the memory of the programmable digital processor, and include the FIFO and the state previously discussed, as well as other items to be introduced below.

FIG. 8 shows a flowchart of the capture thread in an illustrative embodiment. The thread is an infinite loop where each iteration starts at capture start block 810 and proceeds to capture continue block 812, after which a new iteration begins. The capture thread uses data structures including state 800 and FIFO 802, both previously discussed, and idle interval 804 and inactive lag limit 806, to be discussed below.

Idle test block 820 tests whether state 800 is idle. If idle, flush block 840 flushes FIFO 802, idle wait block 842 waits for a time (or encoder count) specified by idle interval 804, and signal block 844 sets state 800 to inactive to signal the analyze thread (further described below) that the idle interval has ended. If not idle, lag limit block 830 waits for either state 800 to be not inactive, or FIFO 802 to contain fewer than a number of frames specified by inactive lag limit 806. In an illustrative embodiment, inactive lag limit 806 is 3. Capture block 850 captures the next frame, and put block 852 puts it into FIFO 802.

Idle interval 804 specifies the length of idle step 750 (FIG. 7), and can be set by means of a human-machine interface, such as that shown in FIG. 34 of Vision Detector Method and Apparatus, derived from other information, such as shown in FIG. 16 of Parameter Setting Method and Apparatus, or obtained in other ways that will occur to those of ordinary skill in the art.

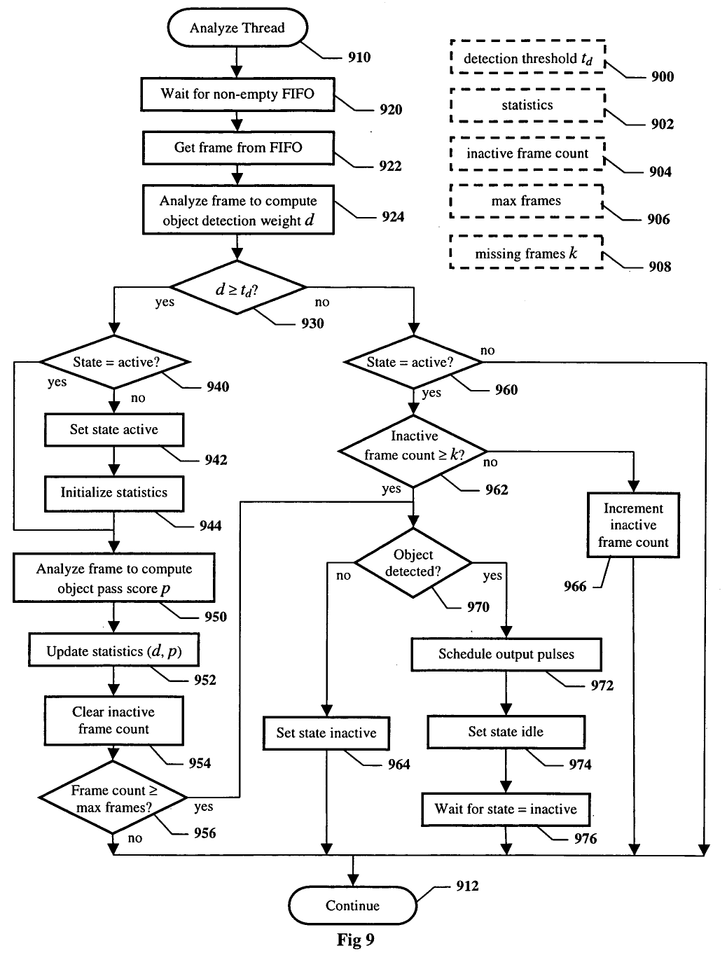

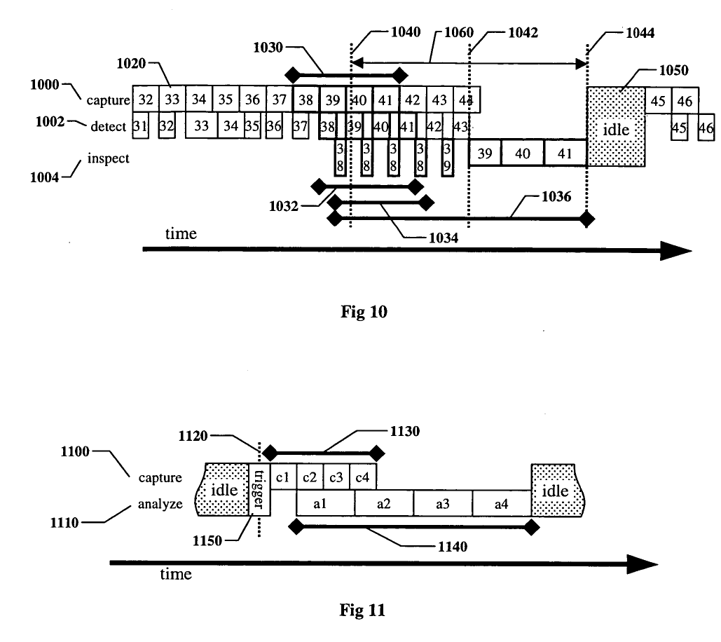

FIG. 9 shows a flowchart of the analyze thread in an illustrative embodiment. The thread is an infinite loop where each iteration starts at analyze start block 910 and proceeds to analyze continue block 912, after which a new iteration begins. The analyze thread uses data structures including state 800 and FIFO 802, both previously discussed (FIG. 8), and decision threshold 900, statistics 902, inactive frame count 904, max frames parameter 906, and missing frames parameter 908, to be discussed below.

FIFO wait block 920 waits for FIFO 802 to contain at least one frame, so that there is something to analyze, get block 922 gets the first-in (oldest) frame from FIFO 802, and detection analysis block 924 runs object detection substeps of frame analysis to compute an object detection weight d.

Detection test block 930 compares the object detection weight to detection threshold 900 to see if an object appears to be present (i.e. see if the frame is active). If so, first active test block 940 tests whether state 800 is active. If not active, the first active frame of a possible new object has been found, and active set block 942 sets state 800 to active and initialize block 944 initializes statistics 902. If state 800 was already active, active set block 942 and initialize block 944 are skipped. Inspection analysis block 950 runs object inspection substeps of frame analysis to compute an object pass score p, and update block 952 updates statistics 902 based on the object detection weight d and object pass score p for the current frame. Clear block 954 sets inactive frame count 904, which counts consecutive inactive frames found during an active state, to zero.

Statistics 902 contains various statistics of a set of active frames that might be useful in judging whether an object has actually been detected, and if so whether it passes inspection. Examples of useful statistics can be found in Vision Detector Method and Apparatus, and others will occur to one of ordinary skill in the art. Statistics 902 includes a count of the active frames found during the current active state, and may also include a count of all frames found during the current active state.

Limit test block 956 compares a frame count, part of statistics 902, to max frames parameter 906 to see if a sufficient number of frames has been seen to make an inspection decision, and to control the number of frames analyzed during an active state so that object detection and inspection will not take too long and FIFO 802 will not overflow.

If detection test block 930 judges that no object appears to be present (inactive frame), second active test block 960 tests whether state 800 is active. If so, termination test block 962 compares inactive frame count 904 to missing frames parameter 908 to see if enough consecutive inactive frames have been found to terminate object detection and inspection. If object detection and inspection will continue, increment block 966 adds 1 to inactive frame count 904. If object detection and inspection will terminate, object test block 970 examines statistics 902 to judge whether an object has actually been detected. If not, inactive set block 964 sets state 800 inactive, and the vision detector is ready to detect another object. If so, output block 972 computes a mark time and schedules appropriate output pulses to occur at a later time or encoder count synchronized with the mark time, or provides for other output reports as required. Idle set block 974 sets state 800 to idle to signal the capture thread that an idle step should begin, and inactive wait block 976 waits for state 800 to be inactive, which is a signal from the capture thread that FIFO 802 has been flushed and a new detection and inspection cycle can begin.

Max frames parameter 906 and missing frames parameter 908 can be set by means of a human-machine interface, such as that shown in FIG. 34 of Vision Detector Method and Apparatus, derived from other information, such as shown in FIG. 16 of Parameter Setting Method and Apparatus, or obtained in other ways that will occur to those of ordinary skill in the art. In an illustrative embodiment, detection threshold 900 is 0.5.

It is essential that the capture and analysis threads be designed according to good multi-threaded programming practices to avoid critical races. One must assume that execution of the threads is completely asynchronous. For example, one must assume that state 800 might be idle during lag limit block 830, even though it appears that the capture thread cannot get to that block if state 800 is idle. The analysis thread can change state 800 at any time, however. If lag limit block 830 waited for state≠active instead of state # inactive, which might seem an equivalent test, the capture thread could be in lag wait block 830 in the idle state, with the acquire thread waiting at inactive wait block 976, which would cause both threads to hang forever.

FIG. 10 shows a timeline of a typical operating cycle for an alternate illustrative embodiment of a vision detector using visual event detection to detect objects, and operating according to the present invention. Capture row 1000 shows image capture steps, including example capture step 1020 that captures frame 33 in the illustrated sequence (the frame numbers are arbitrary). Detection row 1002 shows that portion of the image analysis steps for the indicated frames that corresponds to detection substeps, and inspection row 1004 shows that portion of the image analysis steps for the indicated frames that corresponds to inspection substeps.

Note that capture and analysis are overlapped (happen at the same time), as they are in the timelines of FIGS. 2, 3, 4, and 7, but detection and inspection are not overlapped-one or the other is happening at a given time but never both. This arises from the nature of typical embodiments of machine vision and vision detector systems. These systems, an illustrative embodiment of which is further described below, provide hardware elements for image capture simultaneous with digital processing steps including image analysis. Since these systems have only one processor, however, the detection and inspection substeps of FIG. 10 must share time on that processor. It will be obvious to one skilled in the art that a system with more than one processor can be used to allow the detection and inspection substeps to be simultaneous, but the increased cost and complexity usually makes such a design less desirable.

Note further that the inspection substeps of certain frames, for example frames 38 and 39, are spread out over multiple separate non-contiguous intervals of time. Inspection of frame 38, for example, occurs during four separate intervals contained within example interval 1034. These separate intervals do not correspond to individual inspection substeps, they simply represent time during which the processor is available to perform inspection, which is a lower priority than detection. In the example of FIG. 10 each of these separate intervals is associated with the inspection of one frame, but that is only to make the example easier to illustrate. In practice, the switch from inspecting one frame to the next can happen at any time during the portions of inspection interval 1036 where the processor is available to perform inspection.

In the example of FIG. 10, an object is present in the field of view of the vision detector during the capture of four frames 38-41, corresponding to capture interval 1030, whose capture steps are highlighted with a thick border. The object crosses the mark point at mark time 1040. These frames are analyzed for object detection during detection interval 1032, and for object inspection during inspection interval 1036, with detection and inspection steps also highlighted with a thick border. Frames 38-41 are the active frames for this object. Consecutive inactive frames 42 and 43 terminate detection, but inspection continues as shown. A decision that an object has indeed been detected is made at detection decision time 1042, and a decision of whether or not it passes inspection is made at final decision time 1044, after which idle step 1050 is entered. Note that frame 44, whose capture began just prior to first decision time 1042, is discarded without being analyzed.

In some embodiments, image capture may slow down simultaneous analysis somewhat, due to competition for access to memory (such is the case for the illustrative embodiment of FIG. 13 described below). In other embodiments where there is no such competition, decision delay 1060, measured from mark time 1040 to final decision time 1044, will be essentially identical to decision delay 760 of the illustrative embodiment of FIG. 7, because the same total analysis work must be done regardless of the order in which it is carried out.

The advantages of the alternate illustrative embodiment of FIG. 10 over that of FIG. 7 arise from making the object detection decision much sooner, at detection decision time 1042. Image capture can be stopped, eliminating any competition for memory and thereby speeding up analysis somewhat for embodiments where competition would be present. Furthermore, if at detection decision time 1042 it is decided that no object was detected, inspection substeps can be stopped and the vision detector can return much sooner to the inactive state looking for the next object. Other advantages will occur to those of ordinary skill in the art.

The disadvantages of the alternate illustrative embodiment of FIG. 10 result primarily from an increase in software complexity. The choice among the illustrative embodiments of FIGS. 7 and 10, and other embodiments according to the invention that will occur to one of ordinary skill in the art, is an engineering tradeoff that can be made according to the requirements of a given application of the invention.

In an illustrative embodiment according to FIG. 10, software instructions provide for multi-threaded operation. Three threads run concurrently, one for frame capture, one for object detection, and one for object inspection. It is desirable that the capture thread run at a higher priority, the detection thread at a middle priority, and the inspection thread at lower priority. Other threads may be running as well, depending on the application. Following the teachings of FIGS. 8, 9, and 10, flowcharts and data structures for the three threads can be constructed by one of ordinary skill in the art.

Note that a simple FIFO, as used for the prior art machine vision system of FIG. 2 and the illustrative embodiment of FIG. 7, must be augmented somewhat for use by the alternate illustrative embodiment of FIG. 10. A FIFO can be used with frames added by the capture thread and removed by the inspection thread, but with the FIFO augmented to provide access by the detection thread to other frames that it contains.

It is also possible to use two FIFOs. Frames would be added to the first FIFO by the capture thread, removed and added to the second FIFO by the detection thread, and removed from the second FIFO by the inspection thread. Pointer manipulation methods would be used to avoid actually copying any frames. These and other alternatives are straightforward programming tasks for one of ordinary skill in the art.

FIG. 11 shows a timeline of a typical operating cycle for an illustrative embodiment of a vision detector using an external trigger and operating according to the present invention. Capture row 1100 shows image capture steps, and analysis row 1110 shows image analysis steps. Following trigger step 1150, which indicates that an object is present in the field of view and corresponds to mark time 1120, a configurable number of frames are captured during capture interval 1130 and added to a FIFO. The frames are analyzed and removed from the FIFO during analyze interval 1140. Two threads can be used as taught above; programming details are straightforward. More information on the use of an external trigger is found in Vision Detector Method and Apparatus and Parameter Setting Method and Apparatus.

Illustrative Apparatus

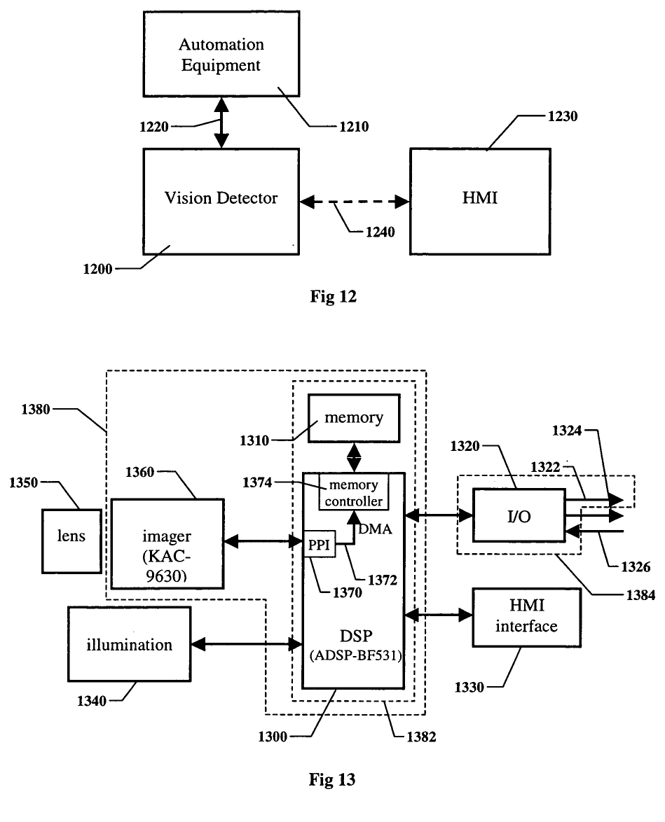

FIG. 12 shows a high-level block diagram for a vision detector in a production environment. A vision detector 1200 is connected to appropriate automation equipment 1210, which may include PLCs, reject actuators, and/or photodetectors, by means of signals 1220. The vision detector may also be connected to a human-machine interface (HMI) 1230, such as a PC or hand-held device, by means of signals 1240. The HMI is used for setup and monitoring, and may be removed during normal production use. The signals can be implemented in any acceptable format and/or protocol and transmitted in a wired or wireless form.

FIG. 13 shows a block diagram of an illustrative embodiment of a vision detector. A digital signal processor (DSP) 1300 runs software to control capture, analysis, reporting, HMI communications, and any other appropriate functions needed by the vision detector. The DSP 1300 is interfaced to a memory 1310, which includes high speed random access memory for programs and data and non-volatile memory to hold programs and setup information when power is removed. The DSP is also connected to an I/O module 1320 that provides signals to automation equipment, an HMI interface 1330, an illumination module 1340, and an imager 1360. A lens 1350 focuses images onto the photosensitive elements of the imager 1360.

The DSP 1300 can be any device capable of digital computation, information storage, and interface to other digital elements, including but not limited to a general-purpose computer, a PLC, or a microprocessor. It is desirable that the DSP 1300 be inexpensive but fast enough to handle a high frame rate. It is further desirable that it be capable of receiving and storing pixel data from the imager simultaneously with image analysis.

In the illustrative embodiment of FIG. 9, the DSP 1300 is an ADSP-BF531 manufactured by Analog Devices of Norwood, Mass. The Parallel Peripheral Interface (PPI) 1370 of the ADSP-BF531 DSP 1300 receives pixel data from the imager 1360, and sends the data to memory controller 1374 via Direct Memory Access (DMA) channel 1372 for storage in memory 1310. The use of the PPI 1370 and DMA 1372 allows, under appropriate software control, image capture to occur simultaneously with any other analysis performed by the DSP 1300. Software instructions to control the PPI 1370 and DMA 1372 can be implemented by one of ordinary skill in the art following the programming instructions contained in the ADSP-BF533 Blackfin Processor Hardware Reference (part number 82-002005-01), and the Blackfin Processor Instruction Set Reference (part number 82-000410-14), both incorporated herein by reference. Note that the ADSP-BF531, and the compatible ADSP-BF532 and ADSP-BF533 devices, have identical programming instructions and can be used interchangeably in this illustrative embodiment to obtain an appropriate price/performance tradeoff.

The high frame rate desired by a vision detector suggests the use of an imager unlike those that have been used in prior art vision systems. It is desirable that the imager be unusually light sensitive, so that it can operate with extremely short shutter times using inexpensive illumination. It is further desirable that it be able to digitize and transmit pixel data to the DSP far faster than prior art vision systems. It is moreover desirable that it be inexpensive and have a global shutter.

These objectives may be met by choosing an imager with much higher light sensitivity and lower resolution than those used by prior art vision systems. In the illustrative embodiment of FIG. 9, the imager 1360 is a KAC-9630 manufactured by Eastman Kodak of Rochester, N.Y. (identical to the LM9630 formerly manufactured by National Semiconductor of Santa Clara, Calif.). The KAC-9630 has an array of 128 by 100 pixels, for a total of 12800, about 24 times fewer than typical prior art vision systems. The pixels are relatively large at 20 microns square, providing high light sensitivity. The KAC-9630 can provide 500 frames per second when set for a 300 microsecond shutter time, and is sensitive enough (in most cases) to allow a 300 microsecond shutter using LED illumination. This resolution would be considered far too low for a vision system, but is quite sufficient for the feature detection tasks that are the objectives of the present invention. Electrical interface and software control of the KAC-9630 can be implemented by one of ordinary skill in the art following the instructions contained in the KAC-9630 Data Sheet, Rev 1.1, September 2004, which is incorporated herein by reference.

It is desirable that the illumination 1340 be inexpensive and yet bright enough to allow short shutter times. In an illustrative embodiment, a bank of high-intensity red LEDs operating at 630 nanometers is used, for example the HLMP-ED25 manufactured by Agilent Technologies. In another embodiment, high-intensity white LEDs are used to implement desired illumination.

In the illustrative embodiment of FIG. 9, the I/O module 1320 provides output signals 1322 and 1324, and input signal 1326. One such output signal can be used to provide a signal for report step 360 (FIG. 3), for example to control a reject actuator. Input signal 1326 can be used to provide an external trigger.

As used herein an image capture device provides means to capture and store a digital image. In the illustrative embodiment of FIG. 13, image capture device 1380 comprises a DSP 1300, imager 1360, memory 1310, and associated electrical interfaces and software instructions.

As used herein an analyzer provides means for analysis of digital data, including but not limited to a digital image. In the illustrative embodiment of FIG. 13, analyzer 1382 comprises a DSP 1300, a memory 1310, and associated electrical interfaces and software instructions.

As used herein an output signaler provides means to produce an output signal responsive to an analysis. In the illustrative embodiment of FIG. 13, output signaler 1384 comprises an I/O module 1320 and an output signal 1322.

As used herein a process refers to systematic set of actions directed to some purpose, carried out by any suitable apparatus, including but not limited to a mechanism, device, component, software, or firmware, or any combination thereof that work together in one location or a variety of locations to carry out the intended actions.

In an illustrative embodiment, various processes used by the present invention are carried out by an interacting collection of digital hardware elements and computer software instructions. These hardware elements include
DSP 1300, which provides general-purpose information processing actions under control of suitable computer software instructions;
memory 1310, which provides storage and retrieval actions for images, data, and computer software instructions;
imager 1360, which provides, in combination with other elements as described herein, image capture actions;
I/O module 1320, which provides interface and signaling actions; and
HMI interface 1330, which provides human-machine interface actions.

In an illustrative embodiment the computer software instructions include those for carrying out actions described herein, and in Vision Detector Method and Apparatus, Parameter Setting Method and Apparatus, and Event Detection Method and Apparatus, for such functions as:
image capture;
image analysis;
object detection substeps;
object inspection substeps;
multi-threaded operation;
FIFO buffer management;
human-machine interface;
mark time computation; and
output signaling.

Furthermore, it will be understood by those skilled in the art that the above is a list of examples only. It is not exhaustive, and suitable computer software instructions may be used in illustrative embodiments to carry out any suitable process.

Examples of processes described herein include:
a capture process, an example of which is shown in FIG. 8, and carried out by image capture device 1380 and suitable computer software instructions;
a variety of analysis processes, including but not limited to object detection and object inspection, an example of one such process being the analysis thread of FIG. 9, and carried out by analyzer 1382 and suitable computer software instructions;
a frame count limiting process that predicts and/or controls the active state frame count as described above, comprising in the illustrative embodiment of FIG. 9 max frames parameter 906 and limit test block 956, and carried out by analyzer 1382 and suitable computer software instructions;
a lag limiting process that limits the lag time during an inactive state as described above, comprising in the illustrative embodiment of FIG. 8 inactive lag limit 806 and lag limit block 830, and carried out by analyzer 1382 and suitable computer software instructions;
a FIFO flushing process that empties a FIFO during an idle state as described above, comprising in the illustrative embodiment of FIG. 8 flush block 840, and carried out by analyzer 1382 and suitable computer software instructions;
a marking process that computes the time (or encoder count) at which an object crosses a fixed reference point, and carried out by analyzer 1382 and suitable computer software instructions;
a signaling process that provides output pulses synchronized to the mark time, and carried out by analyzer 1382, output signaler 1384, and suitable computer software instructions.

It will be understood by one of ordinary skill that there are many alternate arrangements, devices, and software instructions that could be used within the scope of the invention to implement an image capture device 1380, analyzer 1382, and output signaler 1384. Similarly, many alternate arrangements, devices, and software instructions could be used within the scope of the invention to carry out the processes described herein.

A variety of engineering tradeoffs can be made to provide efficient operation of an apparatus according to the present invention for a specific application. Consider the following definitions:
b fraction of the FOV occupied by the portion of the object that contains the visible features to be inspected, determined by choosing the optical magnification of the lens 1350 so as to achieve good use of the available resolution of imager 1360;
e fraction of the FOV to be used as a margin of error;
n desired minimum number of frames in which each object will typically be seen;
s spacing between objects as a multiple of the FOV, generally determined by manufacturing conditions;
p object presentation rate, generally determined by manufacturing conditions;
m maximum fraction of the FOV that the object will move between successive frames, chosen based on above values; and
r minimum frame rate, chosen based on above values.

From these definitions it can be seen that

$$m \leq \frac{1 - b - e}{n} and r \geq \frac{sp}{m}$$

To achieve good use of the available resolution of the imager, it is desirable that b is at least 50%. For dynamic image analysis, n should be at least 2. Therefore it is further desirable that the object moves no more than about one-quarter of the field of view between successive frames.

In an illustrative embodiment, reasonable values might be b=75%, e=5%, and n=4. This implies that m≦5%, i.e. that one would choose a frame rate so that an object would move no more than about 5% of the FOV between frames. If manufacturing conditions were such that s=2, then the frame rate r would need to be at least approximately 40 times the object presentation rate p. To handle an object presentation rate of 5 Hz, which is fairly typical of industrial manufacturing, the desired frame rate would be at least around 200 Hz. This rate could be achieved using an KAC-9630 with at most a 3.3 millisecond shutter time, as long as the image analysis is arranged so as to fit within the 5 millisecond frame period. Using available technology, it would be feasible to achieve this rate using an imager containing up to about 40,000 pixels.

With the same illustrative embodiment and a higher object presentation rate of 12.5 Hz, the desired frame rate would be at least approximately 500 Hz. An KAC-9630 could handle this rate by using at most a 300 microsecond shutter.

In another illustrative embodiment, one might choose b=75%, e=15%, and n=5, so that m≦2%. With s=2 and p=5 Hz, the desired frame rate would again be at least approximately 500 Hz.

The foregoing has been a detailed description of various embodiments of the invention. It is expressly contemplated that a wide range of modifications and additions can be made hereto without departing from the spirit and scope of this invention. For example, the processors and computing devices herein are exemplary and a variety of processors and computers, both standalone and distributed can be employed to perform computations herein. Likewise, the imager and other vision components described herein are exemplary and improved or differing components can be employed within the teachings of this invention. The timing diagrams can all be modified or replaced with equivalents as appropriate for specific applications of the invention. Accordingly, this description is meant to be taken only by way of example, and not to otherwise limit the scope of this invention.

1. A method for detecting and inspecting an object, comprising:
capturing a sequence of frames, each frame in the sequence of frames comprising an image of a field of view, the sequence of frames comprising a first plurality of frames for which the object is not present in the field of view and a second plurality of frames for which the object is present in the field of view; and
analyzing each frame in the sequence of frames to detect and inspect the object, wherein the analysis is responsive to the first plurality of frames and the second plurality of frames, and wherein capture and analysis of frames are substantially asynchronous.

2. The method of claim 1 wherein analyzing a frame in the sequence of frames takes less time when the object does not appear to be present in the field of view than when the object does appear to be present.

3. The method of claim 2, wherein
analyzing a frame in the sequence of frames comprises at least one detection substep and at least one inspection substep; and
at least one inspection substep is skipped when the at least one detection substep determines that the object does not appear to be present in the field of view, resulting in less time being taken to analyze the frame.

4. The method of claim 1, further comprising
using a first thread to control capturing the sequence of frames; and
using a second thread to control analyzing the sequence of frames.

5. The method of claim 1, wherein the second plurality of frames has a count comprising the number of frames in the second plurality of frames, and further comprising limiting the count so as not to exceed a predefined value.

6. The method of claim 1, wherein
capturing a frame in the first plurality of frames begins at a first time;
analyzing a frame in the first plurality of frames begins at a second time, the second time being later than the first time by a lag time;
and further comprising
limiting the lag time responsive to a predefined value.

7. The method of claim 1 further comprising
capturing at least one additional frame; and
flushing without analyzing the at least one additional frame when analyzing the sequence of frames reveals that analyzing the at least one additional frame is not necessary to detect and inspect the object.

8. The method of claim 1 wherein
analyzing a frame in the sequence of frames comprises at least one detection substep and at least one inspection substep; and
the at least one detection substep and the at least one inspection substep are substantially asynchronous.

9. The method of claim 8, further comprising
using a first thread to control capturing the sequence of frames;
using a second thread to control the at least one detection substep; and
using a third thread to control the at least one inspection substep.

10. The method of claim 1 wherein capturing the second plurality of frames occurs at a higher rate than capturing the first plurality of frames.

11. A system for detecting and inspecting an object, comprising:
a capture process that captures a sequence of frames, each frame in the sequence of frames comprising an image of a field of view, the sequence of frames comprising a first plurality of frames for which the object is not present in the field of view and a second plurality of frames for which the object is present in the field of view; and
an analysis process that analyzes each frame in the sequence of frames to detect and inspect the object, wherein the analysis is responsive to the first plurality of frames and the second plurality of frames, and wherein the capture process and the analysis process are substantially asynchronous.

12. The system of claim 11 wherein the analysis of a frame in the sequence of frames takes less time when the object does not appear to be present in the field of view than when the object does appear to be present.

13. The system of claim 12, wherein
the analysis process comprises a detection process and an inspection process; and
for any frame wherein the detection process determines that the object does not appear to be present in the field of view, the inspection process is skipped, resulting in less time being taken to analyze the frame.

14. The system of claim 11, further comprising
a first thread that controls the capture process; and
a second thread that controls the analysis process.

15. The system of claim 11, wherein the second plurality of frames has a count comprising the number of frames in the second plurality of frames, and further comprising a frame count limiting process that limits the count so as not to exceed a predefined value.

16. The system of claim 11, wherein
capturing a frame in the first plurality of frames begins at a first time;
analyzing a frame in the first plurality of frames begins at a second time, the second time being later than the first time by a lag time;
and further comprising
a lag limiting process that limits the lag time responsive to a predefined value.

17. The system of claim 11 wherein the capture process captures at least one additional frame, and further comprising a flushing process that flushes without analyzing the at least one additional frame when the analysis process reveals that analyzing the at least one additional frame is not necessary to detect and inspect the object.

18. The system of claim 11 wherein
the analysis process comprises a detection process and an inspection process; and
the detection process and the inspection process are substantially asynchronous.

19. The system of claim 18, further comprising
a first thread that controls the capture process;
a second thread that controls the detection process; and
a third thread that controls the inspection process.

20. The system of claim 11 wherein the capture process captures the second plurality of frames at a higher rate than the first plurality of frames.
